(19) United States
(12) Patent Application Publication
(10) Pub. No.: US 2013/0178990 A1
(43) Pub. Date: Jul. 11, 2013

(54) Triangulated Rules Engine

(71) Applicants: Bradley Kayton, Hollis, NH (US); Jon Rappaport, Mathews, NC (US); Jacob Stuart Michael Beal, Somerville, MA (US)

(72) Inventors: Bradley Kayton, Hollis, NH (US); Jon Rappaport, Mathews, NC (US); Jacob Stuart Michael Beal, Somerville, MA (US)

(21) Appl. No.: 13/549,245

(22) Filed: Jul. 13, 2012

Related U.S. Application Data
(60) Provisional application No. 61/508,040, filed on Jul. 14, 2011.
(60) Provisional application No. 61/507,578, filed on Jul. 13, 2011.

(51) Int. Cl. G05F 3/00

(52) U.S. Cl. CPC G05F 3/00
USPC 700/286

(57) ABSTRACT

The present invention is directed to a system and method for implementing demand-response operations with interoperating rules engines in a smart grid, and for implementing demand-response operations with interoperating rules engines distributed throughout the system in a smart grid.

### CROSS-REFERENCE TO RELATED APPLICATIONS

The present application is a continuation application of U.S. provisional patent application, Ser. No. 61/508,040, filed Jul. 14, 2011, for Triangulated Rules Engine, by Bradley Kayton and Jon Rappaport, and provisional patent application, Ser. No. 61/507,578, filed Jul. 13, 20122, for System and Method for Reliability Pricing Model Assurance, by Bradley Kayton and Jon Rappaport, both included by reference herein and for which benefit of the priority date is hereby claimed.

### FEDERALLY SPONSORED RESEARCH

Not applicable.

### SEQUENCE LISTING OR PROGRAM

Not applicable.

### FIELD OF INVENTION

The present invention relates to electrical energy systems and, more particularly, to smart electrical grids.

### BACKGROUND OF THE INVENTION

Increasingly, energy efficiency programs are being considered energy resources and consequently are built into integrated resource plans to meet forecasted load. The challenge is that most are poorly metered or unmetered resources and lack flexibility and a level of intelligent configuration for the consumer and from the device. Moreover, there is little to no correlation to the outlines of the program offered from electric utilities to the desires of the consumer, especially on a flexible or adjustable manner, or based on the capabilities and durability of the devices under energy management control. The impact the programs have in aggregate on meeting energy demand must be must be implemented by a distributed set of rules engines that interoperate and correlate among the needs or programmed logic among the constituents of the local electric utility, the energy consumer, and the device itself under energy management control.

Existing energy systems are plagued by high variability in demand for power and the lack of effective control over the demand. For example, peak electrical consumption (in terms of wattage) is much higher than average consumption, but the total duration of peak consumption is relatively short. It can be costly to maintain the surge capacity that is only needed during peak consumption periods. As a result, utility companies increasingly are forced to resort to brown-outs and/or black-outs when capacity is insufficient. This practice has many negative impacts on the residents and businesses in the service area, as well as monetary penalties and bad PR for the local electric utilities.

Some research has been done in recent years to develop more cost effective and less intrusive methods for easing the strains on existing energy systems. For example, studies have shown that there is a high level of flexibility in actual consumer requirements, and therefore it is possible in theory to reduce peak consumption without depriving consumers of energy they are unwilling to give up.

One conventional approach is to encourage consumers to conserve energy voluntarily by increasing their awareness of energy consumption. For example, studies have shown that information about energy consumption of consumers relative to their neighbors can cause high-usage energy consumers to dramatically reduce their consumption. Also, studies conducted in California have shown that consumers given a “mood ring” that indicates in real time the stress on the power grid dramatically reduced their peak-time consumption.

Another conventional approach is to use energy pricing, either in real or virtual currency, to gauge each consumer's willingness to reduce consumption. In these so-called market-based systems, the price of energy is allowed to fluctuate in real time based on actual demand, which provides an economic incentive for consumers to reduce consumption when the actual demand is high. The rationale behind these systems is that the price a consumer is willing to pay for energy is inversely related to the consumer's willingness to reduce energy consumption, so that a consumer who is more willing to reduce energy consumption will do so at a lower price point compared to another consumer who is less willing to reduce energy consumption. Thus, as the market finds equilibrium, the system approaches a desired state where each consumer reduces energy consumption only to the extent he is willing.

Conventional systems have also been developed to control energy demand related to heating and/or cooling in a building. Typically, these systems employ a centralized architecture where a central controller collects information from various sources and provides control signals to heating and/or cooling units based on the collected information.

New methods of demand-response are desirable to overcome the shortcomings of conventional systems. However, utilities are reluctant to undergo significant changes, such as implementing new methods of demand-response management, without significant corroboration of benefit and palpable sense of operation.

Some utilities have demand response program that use a rules engine, a set of program rules. These energy management program rules could include items such as the maximum number of DR calls per months or season, the cycle time lengths of device curtailments, discounts or rebates on the bill for program participation, and the like. Utilities and energy service providers that implement demand response programs use the rules engine in the utility program itself as a form of business logic, and they do not have the ability to interoperate with other rules engines.

It would be advantageous to provide a system that implements demand-response operations with interoperating rules engines. It would also be advantageous to provide a system that implements demand-response operations with interoperating rules engines that are distributed throughout the system. It would further be advantageous to provide a system implements demand-response operations with interoperating rules engines that are distributed throughout the system and protects consumer privacy. These rules engines could be used in real-time collaboration with a wide-scale algorithm for coordinating demand side management activities, providing local micro adjustments for the consumer or from the device, all under the guidelines of the energy management program itself.

### SUMMARY OF THE INVENTION

In accordance with the present invention, there is provided a method and system for implementing demand-response operations with interoperating rules engines in a smart grid. Further in accordance with the present invention, there is provided a method and system for implementing demand-response operations with interoperating rules engines distributed throughout the system in a smart grid. Further in accordance with the present invention, there is provided a method and system for implementing demand-response operations with interoperating rules engines distributed throughout the system, with or without the on-going coordination of a wide-scale algorithm controlling the sum of the parts of all the participating devices/consumers, in a smart grid.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram of various functional components of a triangulated rules engine system.

FIG. 2 is a block diagram of various functional components of a triangulated rules engine system.

FIG. 3 is a block diagram of various functional components of a consumer facility.

FIG. 4 is a block diagram of various functional components of a consumer facility including functional components of a triangulated rules engine system.

FIG. 5 is a block diagram of various functional components of a triangulated rules engine system.

FIG. 6 is a block diagram of an example computer system.

### DETAILED DESCRIPTION

Before the invention is described in further detail, it is to be understood that the invention is not limited to the particular embodiments described, as such may, of course, vary. It is also to be understood that the terminology used herein is for the purpose of describing particular embodiments only, and not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed with the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

It must be noted that as used herein and in the appended claims, the singular forms “a”, “an”, and “the” include plural referents unless the context clearly dictates otherwise.

All publications mentioned herein are incorporated herein by reference to disclose and describe the methods and/or materials in connection with which the publications are cited.

The publications discussed herein are provided solely for their disclosure prior to the filing date of the present application. Nothing herein is to be construed as an admission that the present invention is not entitled to antedate such publication by virtue of prior invention. Further, if dates of publication are provided, they may be different from the actual publication dates and may need to be confirmed independently.

The present invention uses a distributed approach without the necessity of controlling devices in an unconstrained manner. In one embodiment, the system interacts with three constituents of domain response implementations. The constituents comprise 1) the utility; 2) consumer; and 3) devices.

### Utility.

Enterprise software can be connected to a device which is under load control. There are multiple devices that are involved in a load control program. A control module can serve as an energy gateway, and that energy gateway can communicate to a load control module which can communicate to an appliance. All of those devices can be viewed collectively. For example, an appliance that is under load control (rather than the other hardware elements that are in the loop), and under load control to a particular home, for example, two essential systems, an AC system and a hot water heater.

### Consumer.

The second constituent is the consumer who controls the consumer facility, generally a home or small business, and the devices under load control.

Devices. The devices under load control are another constituent.

Each one of those constituents has a rules engine. The rules engines are characterized in software, either directly coordinating among the various rules engines for optimum outcomes or in collaboration with a wide-scale control algorithm, so those constituents can participate in the program as a unified system.

### Rules Engines.

The Utility Rules Engine (URE). The utility rules engine has real world parameters of the demand response program that is being implemented. As an example, some utilities have a summer peaking program for the summer months of June, July and August. The rules in the rules engine provides that with regards to AC systems, the demand response program will only affect the AC system three months out of the year, and only those devices can be touched (i.e., remotely controlled to reduce stress on the energy grid when needed). Constraints can be set, such as a maximum of ten touches for the summer, and of those ten touches, a touch can last for as long as four hours, but of those four hours that the load control is being done, which is touching the thermostat to turn off the compressor. A constraint can be set so that half the time it's under load control, it has to be left on so the customer doesn't notice substantial temperature differentials. For example, a rule could be fifteen minutes on, fifteen minutes off, for a four hour period.

The rules engine store should store the rules in a configurable software system that can be changed either on an annual basis as part of the utility system, or by the consumer, depending on whose rules engine it is.

### The Consumer Rules Engine (CRE).

A consumer rules engine could implement an algorithm and configuration mechanism such as indicating level participation in a demand response program with a color indicator by allowing a consumer to putt a device in a color zone, such as green or yellow or red. The green zone indicates that the device can be touched at any time. The yellow zone indicates that the device should only be touched at periods or peak demand. The red zone indicates that the device should only be touched under critical peak periods or emergencies. A black zone indicates that the device is not participating in the load control program.

### The Device Rules Engine (DRE).

The device rules engine contains a database of devices that can interface with the program. For example, it would be similar to the IR codes for different electronics that are contained in a universal remote control. The system will store the codes for different devices, and will be able to access the ratings for different devices. There could also be a universal rating for the type of device. There could also be different line items that would be different between devices such as a pool pump versus an HVAC system. For example, with an HVAC system you are concerned with such things as how often do you turn the compressor off, for how long does it need to be left off. Other devices would have other characteristics.

The rule set for the device rules engine can be configured so that you get the characterization for how, and how often, a particular device can be used. For example, the age of the devices will affect these parameters. A brand new hot water heater is probably a better target for the system to touch; the electronics are less brittle and less likely to break by being turned off; and may have more options as opposed to just be turned on and off. Other metrics could be used for a priori rules.

The rules can be changed as more information is obtained about the characteristics of the device. Additionally, new information from a device manufacturer can be incorporated into the system. For example, a manufacturer could issue a new specification for a device, and the specification would indicate what particular calls or commands can be issued to the device, and the specification would warrant that compliant commands will not damage the device.

There could be a negotiated determination between two sets of rules engines; for example, if the consumer can indicate that a device can be touched at any time, and the utility would split the savings with the consumer; but the device might not be that durable, so you need to make that determination in real time.

The triangulated rules engine is a distributed logic system which correlates three different constituents under that are part of a demand side energy management program. Triangulation occurs when any two of the constituents negotiates for an outcome and all three constituents participate on all outcomes. The triangulated rules engine makes decisions based on the ratings and the factors, and which ones have precedence. The triangulated rules engine makes a real time decision based on priorities or on math and analytics to determine whether to participate in a particular curtailment call at a particular time.

The triangulated rules engine is resident on the cloud server. In the home, in those homes with an the energy gateway at the heart of the system, the logic resides in two locations; it is distributed in the energy gateway and the cloud server. The server can be located in the cloud, and can contain a master database of device classes containing device ratings and research which could be used to determine their different factors or line items such as durability, age, persistence, and wattage used so that energy load could be curtailed, and in essence determine the load.

All those attributes reside in the database on the server, and over time, there can be many types of device classes. For example, a utility may have a hot water program running In that example, then the system only needs to load up in the server the hot water data. The system downloads that data, the a priori rules, the rating codes, and all the data and information about a particular device, profiles for that particular device, and will then get downloaded to a server which is resident in the back end of the utility and then that is transmitted in real time to the gateway.

When a consumer or installer initially sets up a program, device participation can be selected from a menu list. For example, a utility could implement a hot water heater program. First, the utility would install a device on the appliance. A configuration tool would be used to register the device with the program. This would communicate with the server over a network back to the utility, which would have all of the hot water heater data downloaded from the master database residing in the cloud server. It is available from the server on the network and able to be retrieved in real time with the program.

From the menu list, the consumer or installer would see a long list of hot water heaters, including generic types. The user picks the one make or model or the one that is the closest to the make/model number), and that device information is downloaded from the server down to the energy gateway. This demonstrates the tiering from the master database in the cloud server, all hot water heaters being a subset of the master database loaded into the back-end server at the utility, and the device rule information for a particular hot water heater downloaded from the back-end server to the energy gateway.

The utility rules engine can load in two places: the energy gateway and at the utility up in the network on a server, either in the utility network or hosting facility or in a partitioned Cloud server from a third party. The utilities program will load on the server, but some elements of it will be downloaded at the energy gateway as well for this distributed system. The consumer will use their rules engine on their personal computer, on their mobile phone, or on the device itself, if the device is so configured to allow the consumer to cycle through green, yellow, red (the states of the device) or otherwise provides a user interface. The consumer would then configure the device, whether it's on the device itself or on whether it's on a an in-home display. For example, the consumer could configure the device to be touched at any time by setting the state of the hot water heater to green.

With the consumer rules engine, the system enables the consumer to go in after the initial configuration and change the color rating. For example, the user may want to take the device offline by making it black, or maybe they decided that they don't like the program and only want the device touched in peak moments, and put it in the red zone. With the consumer rules engine, the logic would live in the home only, and not on the server.

Although it's a distributed computing system where the logic is distributed, logically all of the conditions of those three different distributed rules engines “meet in the middle” at the triangulated rules engine to determine what to do at that particular time.

There could also be another virtual rules engine that is not specific to the utility rules engine or the device rules engine. It could be a third party rules engine that applies logic and decision making It could be applied in situations where buildings need to control in aggregate and there is a third party rule that applies at the system level.

In one embodiment of the invention, the ability of the consumer to select yellow, green or red for the state of their device is used to indicate the consumer's level of participation in a demand response program. The triangulated rules engine can apply to the energy space by triangulating different rules and resolving them ultimately as a binary decision.

The triangulated rules engine negotiates between any two constituents and outcome and all three constituents participate on all outcomes , any two of the constituents negotiates for an outcome and all three constituents participate on all outcomes. This allows the system to interact between parties and devices. Because of the way these rules interoperate, the system can provide the aggregate contributions in aggregate to the utilities and individually to the consumer, but they don't necessarily have to know anything about each other.

Between the device and the utilities, the measurement and verification is important. The triangulated rules engine is the trust engine that solves a key problem between each of the constituents, treating end user and the device with simplicity. This allows the randomized distributed probabilistic nature of the system which allows for a level of participation fairness and privacy.

From an architectural perspective, the utility applications and the utility rules engine reside in the utility back-end server; the consumer interacts with the back-end server because the consumer information needs to be protected; the endpoint device rules reside within the device, although some of the rules might be managed by the server; and the cloud server is the architectural host for the analytics services and extra trust engine components that are applied to the system.

In one embodiment, the system has an algorithmic architecture, which layers over an n-tier architecture of a 3-tier software framework, which in turn supports an end-to-end software architecture, and all of which has to support a variety of related business models. Client software, with an embedded system target, resides in the Energy Services Interface (ESI) and communicates to two different servers, initially to the cloud computing network and later to the back-end server of the utilities. It should be appreciated that the software is not limited to only three tiers, other embodiments could reside in the sub-station networks or have two or more embedded software footprints in the home, especially in situations home area networks host multiple ESIs.

The communication architecture for the software system has the modularity and flexibility for the embedded software to run in various end-point devices, while communicating to the server in the network. Since the utility back-end server is behind the utility firewall, the client is designed initially with the cloud server as the data collector, although final deployment could be, as a hybrid model or wholly, over the AMI network. The public Internet link between the cloud server and the back-end server could be configured as “off” to satisfy utility security requirements, but could be worked firmly into the end-to-end architecture.

### Predictive Capabilities.

The system can provide better future predictive capabilities. A utility operator provided with a user interface can run a demand-response program wherein the utility operator is provided with information about the probable outcome. The triangulated rules engine can provide the most accurate pre-event tool as possible, so that a utility operator can confidently predict the outcome of an operation.

A retrospective view of what happens after an event can be provided, as well as a view of what happens in between. There is predicting on the front end, and intelligent learning on the back end. An additional benefit of the present invention is that it could provide a parallel rating system, and results of operations are processed by an artificial intelligence system, so that the system dynamically learns and improves. Since accurate and precise demand side management requires device-level metering which isn't always possible, indeed usually is not possible, the DRE, device codes, and related state information can prove invaluable in providing wattage curtailment as part of the proposed system.

In one embodiment of the present invention, a device initially starts with the set of ratings on the particular device. A given device, or class of devices, can have an individual and aggregate rating. A rating library can rate devices and have ratings for numerous specific devices which can have a static rating. For example, a water heater might use 1.4 kW while operating. The contribution rating of that device is the equivalent of what the device should be able to contribute to that system. The contribution potential is very important, because it resides in the system that provides the feedback loop to the user interfaces and to any wide-scale algorithms, and potentially to even other systems. The potential of that device, or that system, or that location of that system would be that it dynamically adjusts based upon things like base consumers. For example, people have certain behavior characteristics; some people keep adjust their thermostat to keep the environment very cold, or they tend to keep it warm. These are things that affect the contribution potential.

Consequently, when the system looks at what to expect on a given system, it is important to know what the rating is, but it's more important to know what the contribution potential is. That helps increase accuracy of a prediction of what the system should expect from a demand-response call. The contribution margin is the attribute that the system would calculate and use in the particular demand side management equation. So the contribution margin becomes very important because it could be rated all the way down to an individual device, or could also be done in an aggregate rating system at a program level, such as for a hot water heater energy management program.

Another advantage of the present invention is that it can provide a feedback mechanism to a probabilistic system. A demand-response system may be structured where consumers will be paid through some type of peak time rebate or other incentive provided by the utility. With the application of probabilistic computing, the system can apply a contribution margin. For example, if there were 100,000 people participating in the demand-response call, 50% of those could be set to green all the time, and 30% set to yellow, and some other percent were red, and some in override mode. In one embodiment of the present invention, the system has the ability to do an aggregate contribution margin, or individual margins, in order to process rebates to consumers where the utility is paying an aggregator. The system doesn't necessarily know exactly what each consumer contributed, but system is able to determine each level of participation, such as color rating of curtailment preference, one out of the group. Consequently, consumers who were participating in green, who we know had a contribution margin so those people in green represented 50% of the settings but may represent 90% of the value of the demand-response call. The consumers could be rebated based on that contribution margin that they had or the flexibility they provided for curtailment or some combination of the two.

In another embodiment, the system equates to a rating system that feeds the control user interface. The system continues to learn and get smarter, and there is a contribution potential rating that can sit next to every device or node on the user interface. Over time the accuracy will increase, for example the average rating of this might be 93%, and at some point, as the system continues to get smarter, it may achieve a 98% rating. With that accuracy, the utility will know what to expect.

In one embodiment, the system resides on a cloud server. The system can apply to a device or collection of devices. A consumer facility might have an aggregate rating, or even a program for any device from a pool, to a heater. The system on a cloud server can be a combination of a rating system, and a feedback loop to an analytics system, and can be tied in to any transactional application or any user interface.

It is important to understand the total potential for a given device. Observe the overall usage, the contribution data associated with that device, and then extrapolate how to better tune the system based on the contribution potential, as well as how to do transactions on the system, based upon its contribution potential.

Another embodiment handles expectation on different levels of payment. Different cash values to different systems based upon their reliability. The system has means of weighting the value of something. In one embodiment, the loop is the execution of demand-response commands, and the analysis of various classes of devices and how they respond and what their various contributions are.

In one embodiment, the devices have logging collecting all the data and a method to validate. This utilizes all the logged data and produces key metrics for functions that utilities need to use. One embodiment comprises devices, logging, start and validate, which is collecting data, view, and then back around to simulation, customers, end users customers, back down to devices.

In one embodiment, the system resides on a server. In one embodiment, the system is distributed. In one embodiment, the system is tiered. The system can distribute intelligence, different applications, and different applications require different intelligence. In other embodiments, the system is connected to the distribution side, in a substation, or use automated commands instead of user interface.

The system can interact with systems such as the color power algorithmic solution in which a consumer can signal a level of participation in a demand response program using a color indicator. In one embodiment, a rules engine runs as a parallel component of the system. In one embodiment, the system has the access to new data with a fine level of granularity. The system processes the feedback loops and mines the data. The system provides ever more sharp look at how a utility could maximize its value proposition by changing its requests, so that it gets the maximum savings so they can best avoid marginal price changes, so they can best, minimize the amount of payouts that they have to give to consumers for participating. All of those are data points that can be provided by the system. In one embodiment, the system interfaces with processes like settlement, the fairness of the transaction from a transactional basis. The system has the ability to validate.

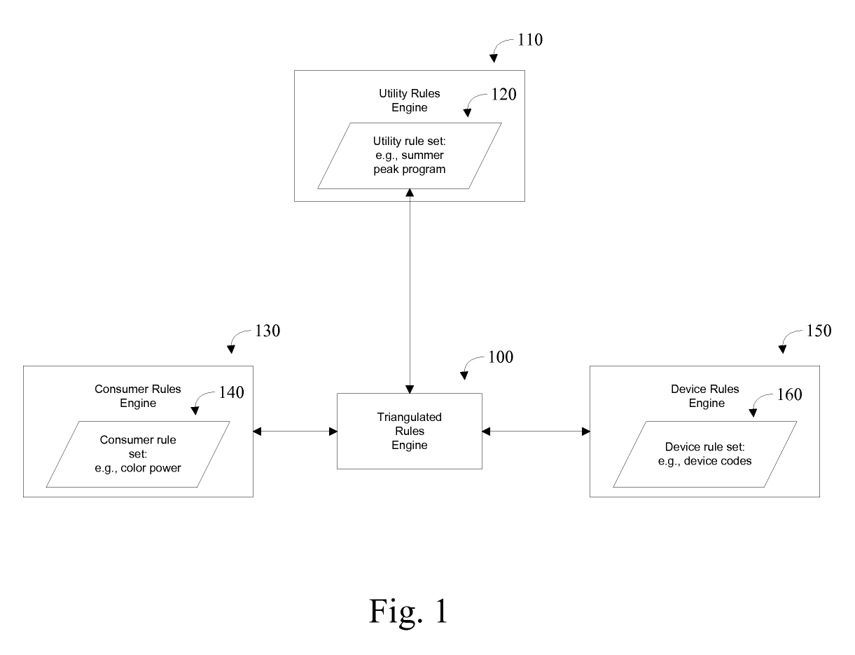

Referring now to FIG. 1, triangulated rules engine 100 is shown in communicatively connected to a utility rules engine 110, a consumer rules engine 130, and a device rules engine 150. Utility rules engine 110 further comprises utility rule set 120. Consumer rules engine 130 further comprises consumer rule set 140. Device rules engine 150 further comprises device rule set 160.

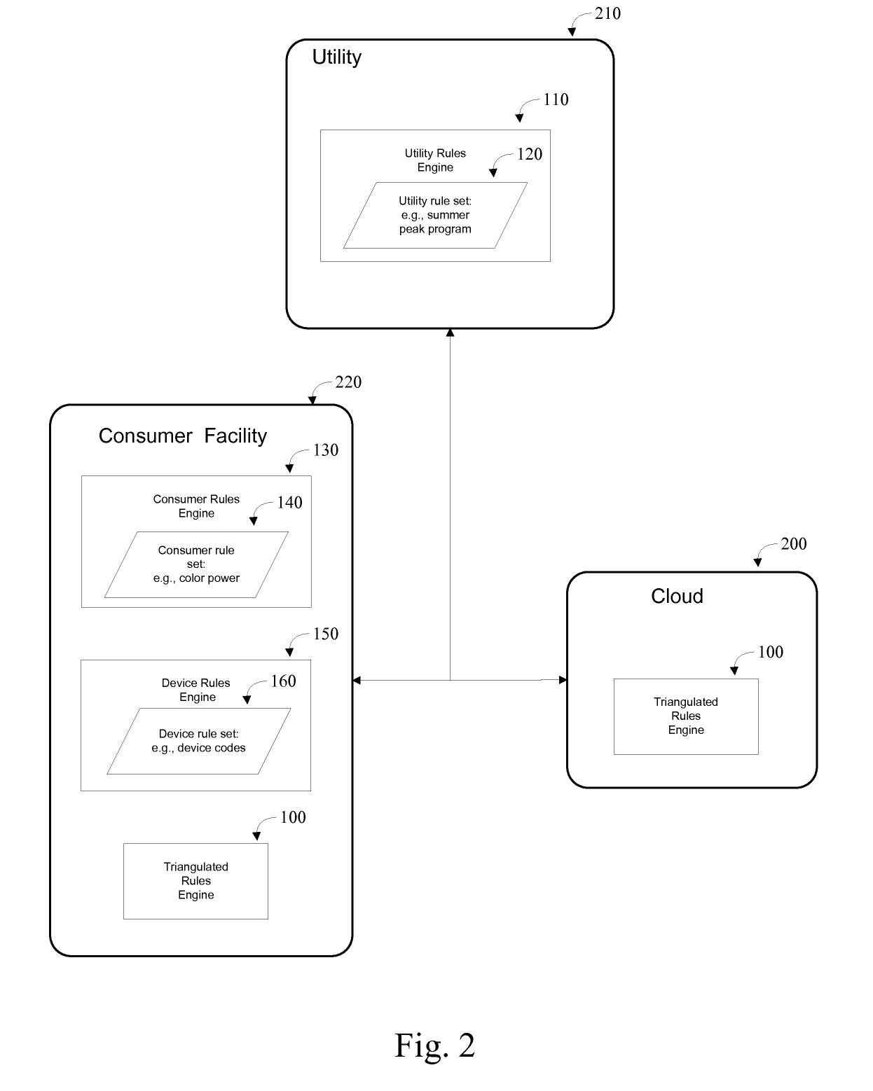

Referring now to FIG. 2, triangulated rules engine 100 is shown located in cloud 200, which can be a cloud based server communicative connected to the Internet. Utility rules engine 110 and utility rule set 120 are located at utility 210. Consumer rules engine 130, consumer rule set 140, device rules engine 150, device rule set 160 and triangulated rules engine 100 are shown located at consumer facility 220.

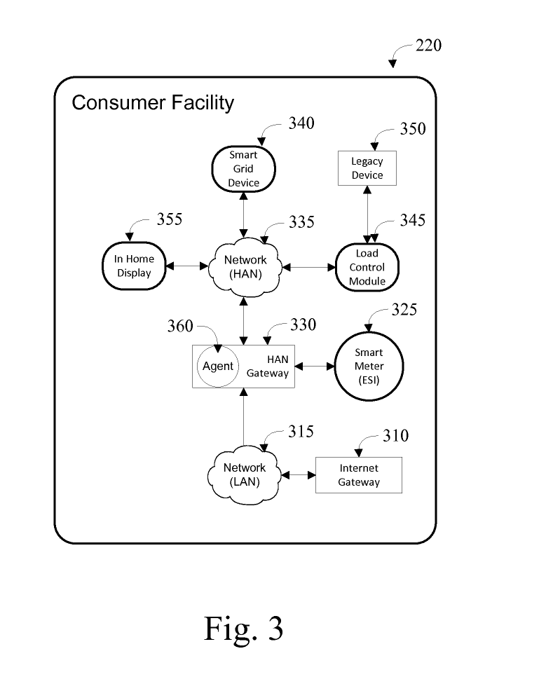

FIG. 3 shows an exemplary configuration of a consumer facility 220. A consumer facility 220 is designated as an energy consumer, which can be an establishment served by an energy utility, such as a residential home, a commercial establishment, or an industrial plant. An energy utility initiates a demand-response event by transmitting a control broadcast message from its server to the consumer facility 220. The control broadcast message can be transmitted to the consumer facility 220 over the public Internet, where the control broadcast message is received by the Internet gateway 310 and routed via the Local Area Network 315 to the Home Area Network gateway 330. Alternatively, the control broadcast message can be transmitted to the consumer facility 300 over another network such as the AMI network, where the control broadcast message can be received by the smart meter 325 and routed to the Home Area Network gateway 330.

The Home Area Network gateway 330 routes the control broadcast message over the Home Area Network 335 to smart grid devices 340 and load control modules 345. Smart grid devices 340 will process the received control broadcast message and perform some action, such as modifying its energy consumption. .Load control modules 345 will process the received control broadcast message and perform some action such as modifying the energy consumption of an attached legacy device 350. A user at the consumer facility 220 can see the actions performed by the smart grid devices 340 and load control modules 345 represented on the in-home display 355. The in-home display 355 can also provide energy budget information, energy pricing, and other useful information to the user related to the energy management program. The in-home display 355 can also provide the user with the ability to manually override actions performed by smart grid devices 340 or load control modules 345.

After performing an action, including the null set of taking no action, the smart grid devices 340 and load control modules 345 report the energy used pursuant to the curtailment demand in the control broadcast message to a software agent 360. The software agent 360 is embedded in the Home Area Network gateway 330 and comprises algorithms and local side control software to achieve the energy program rules and goals. The software agent 360 returns results of the demand-response event to the utility server that initiated the control broadcast message, another server, or an intermediate aggregation node. The software agent 360 can route the results from the Home Area Network gateway 330 over the Local Area Network 315 to the Internet gateway 310. The Internet gateway 310 transmits the data over the Internet 305 to the utility server that initiated the control broadcast message, another server, or an intermediate aggregation node. Alternatively, the software agent 360 can route the results from the Home Area Network gateway 330 to the smart meter 325, which transmits the data over the AMI network 320 to the utility server that initiated the control broadcast message, another server, or an intermediate aggregation node.

Software agent 360 can alternatively be embedded in the smart meter 325. The software agent 360 transmits the results of the demand-response event from the smart meter 325 over the AMI network 320 to the utility server intiated the control broadcast message, other server, or an intermediate aggregation node.

Software agent 360 can alternatively be embedded in the Internet gateway 310.

The software agent 360 transmits the results of the demand-response event from the Internet gateway 310 over the Internet 305 to the utility server that initiated the control broadcast message, another server, or an intermediate aggregation node.

Software agent 360 can alternatively be embedded in a. smart grid device 340. The software agent 360 transmits the results of the demand-response event from the smart grid device 340 over the Home Area Network 335 to the Home Area Network gateway 330. The Home Area Network gateway 330 routes the data to the smart meter 325 which transmits the data over the AMI network to the utility server that initiated the control broadcast message, another server, or an intermediate aggregation node. Alternatively, the Home Area Network gateway 330 routes the data over the Local Area Network 315 to the Internet gateway 310 which transmits the data over the Internet to the utility server that initiated the control broadcast message, another server, or an intermediate aggregation node.

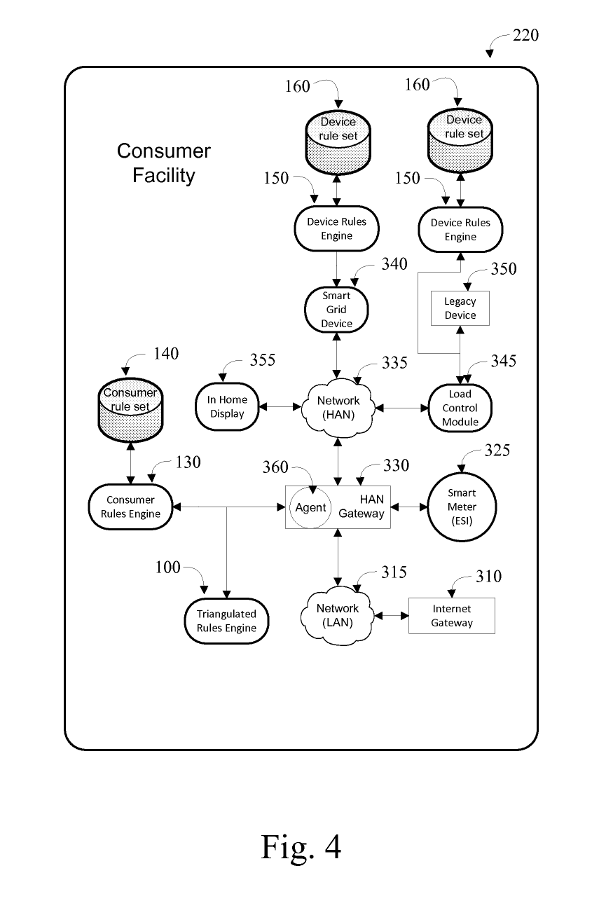

Referring now to FIG. 4, the consumer facility 220 is shown with the triangulated rules engine 100 communicatively connected to the Home Area Network gateway 330. Consumer rule set 140 is communicatively connected to consumer rules engine 140, which in turn is communicatively connected to Home Area Network gateway 330. The consumer rules engine 130 determines which classes of aggregate a device is allowed to join. Device rule set 160 is communicatively connected to device rules engine 150. The device rules engine 150 rates the smart grid devices 150 and load control modules 345 and determines which of the utility aggregates it is allowed to join, if not otherwise constrained by the consumer rules engine 130. Multiple device rules engines 150 may be present and communicatively connected to smart grid devices 340 and load control modules 350.

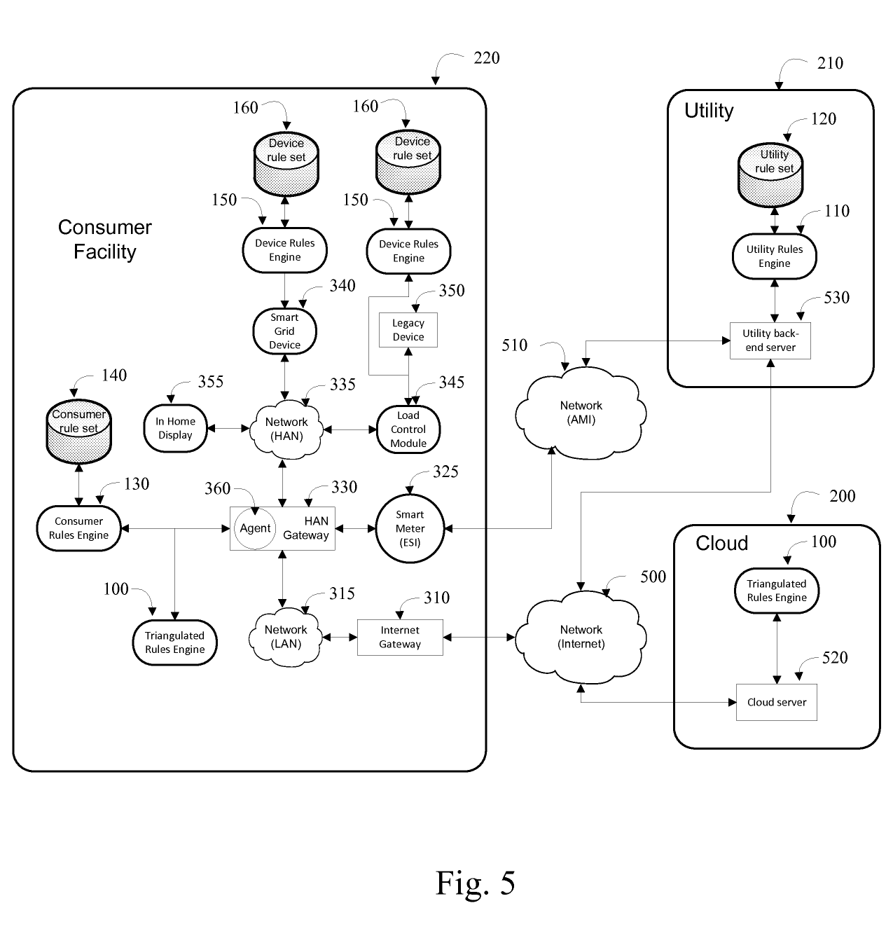

Referring now to FIG. 5, the Utility 210 can set parameters for a demand side management program by configuring rules and parameters in the utility rule set 120. The utility rule set 120 also contains rules pertaining to aggregating abstractions of smart grid devices 350 and load control modules 350 which are accessed by the utility rules engine 110, which can contain logic for all participants or for certain participants that have been enrolled in the demand side management program, as well as determining extant aggregations and management constraints. The demand side management program is run on the utility back-end server 530. In one implementation, the demand side management program could be set-up for both HVAC systems and hot water heaters located at consumer facilities 220. For example, the utility rule set 120 could provide that only three remote turn-offs of a particular smart grid device 340 are allowed per month and when cycling the HVAC it does so no longer than for fifteen minute increments.

The triangulated rules engine 100 has a defined interface and can be distributed throughout the system. The defined interface allows for interaction with arbitrary utility rules engines 110, arbitrary consumer rules engines 130, and arbitrary device rules engines 150. In one embodiment of the present invention, the utility back-end server 520 transmits a demand response call pursuant to a demand side management program to a consumer facility 220 via network, either an AMI network 510 or the Internet 500. If the demand response call is transmitted to the consumer facility 220 over the AMI network 510, it will be routed through the consumer facility 220 via a smart meter 325 and on to the Home Area Network gateway 330. If the demand response call is transmitted to the consumer facility 220 over the Internet 500, it will be routed through the consumer facility 220 via an internet gateway 310, through the Local Area Network, and on to the Home Area Network gateway 330.

If the demand response call requests the curtailment of energy usage or turning off or down a particular smart grid device 340 or load control module 345, the triangulated rules engine 100 will receive the request from the Home Area Network 330 and will interact with the consumer rules engine 140 and any device rules engines 150 resident in the consumer facility 220. The triangulated rules engine 100 is distributed in consumer facility 220 and cloud 200. In one embodiment of the present invention, the triangulated rules engine 100 resident in the consumer facility 220 will send a request for additional information or logic from the triangulated rules engine 100 resident in the cloud 200, said request transmitted through the Home Area Network gateway 330, then through the Local Area Network 315, then through the internet gateway 310, then through the internet 500 to cloud server 520, which communicates the request to the resident triangulated rules engine 100 and returns the requested information or logic via the same network topological pathway. The triangulated rules engine 100 resident at the consumer facility 220 interacts with the consumer rule set 140 through the consumer rules engine and with the device rule set 160 through the device rules engine 150. The triangulated rules engine 100 resolves the various interacting constraints contained in the utility rules engine 110, the consumer rules engine 130, and the device rules engine 150, and determines which devices are allocated to specific aggregates, how they should be managed, and how they should respond to future demand response calls. The allocation to specific aggregates can occur in any part of the distributed triangulated rules engine 100, including consumer facility 220 and cloud 200.

For example, if the demand response call requests curtailment of the HVAC as a smart grid device 340 and a hot water heater connected to a load control module 345 in the consumer facility 220, the triangulated rules engine 100 will request the parameters of the consumer rule set 140 from the consumer rules engine 130, as well as the parameters of the device rule sets 160 from the device rules engines 150 for the smart grid device 340 and load control module 345. The triangulated rules engine 100 will assess whether the demand response call satisfies the constraints of all of the constituents, namely the utility rule set 120, consumer rule set 140, and device rule set 160.

Further, if utility 210 makes a second demand response call, the utility rules engine 110 will check the utility rule set 120 for compliance with the constraints therein. For example, the rule set might allow three remote turn-offs month and when cycling the HVAC may be restricted to fifteen minute increments. The consumer rules engine 130 will check the consumer rule set 140 for compliance with the constraints therein. For example, if the consumer has set their devices to “green” then they have, based on that meaning in the consumer rule set 140, given the utility the right to touch those devices. The device rules engine 150 will check the device rule set 160 for compliance with the constraints therein. For example, if the device is relatively new so there are no durability worries and hasn't been turned off abruptly in the last hour and can contribute an adequate amount of wattage saved at that moment, then it passes the test to be curtailed. The curtailment event is completed at the load control module 345 or smart grid device 340 operating over the home area network 335 or acting directly on the device in question.

The results may be displayed to the consumer on their mobile phone, PC via a Web Portal, or on an In-home Display 355, if present. The demand response call result and duration can be recorded in the triangulated rules engine 100, utility rules engine 110, consumer rules engine 130, device rules engine 150, or any combination thereof.

### Example Computing System

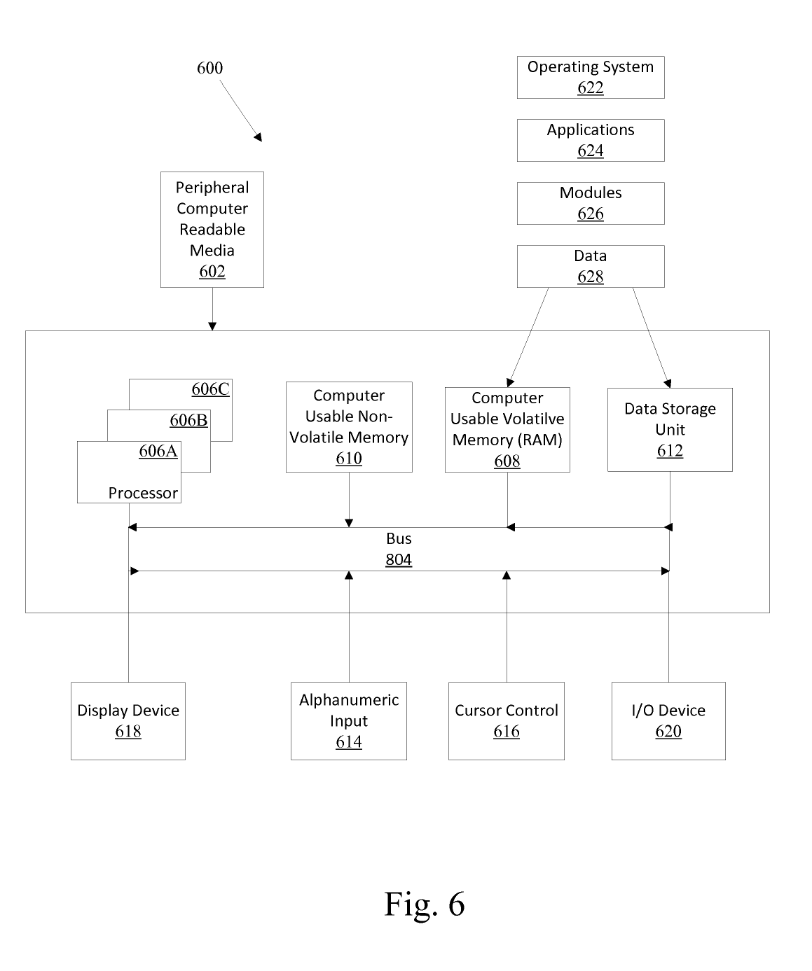

With reference now to FIG. 6, portions of the technology for providing computer-readable and computer-executable instructions that reside, for example, in or on computer-usable media of a computer system. That is, FIG. 6 illustrates one example of a type of computer that can be used to implement one embodiment of the present technology.

Although computer system 600 of FIG. 8 is an example of one embodiment, the present technology is well suited for operation on or with a number of different computer systems including general purpose networked computer systems, embedded computer systems, routers, switches, server devices, user devices, various intermediate devices/artifacts, standalone computer systems, mobile phones, personal data assistants, and the like.

In one embodiment, computer system 600 of FIG. 6 includes peripheral computer readable media 602 such as, for example, a floppy disk, a compact disc, and the like coupled thereto.

Computer system 600 of FIG. 6 also includes an address/data bus 604 for communicating information, and a processor 606A coupled to bus 604 for processing information and instructions. In one embodiment, computer system 600 includes a multi-processor environment in which a plurality of processors 606A, 606B, and 606C are present. Conversely, computer system 00 is also well suited to having a single processor such as, for example, processor 606A. Processors 606A, 606B, and 606C may be any of various types of microprocessors. Computer system 600 also includes data storage features such as a computer usable volatile memory 608, e.g. random access memory (RAM), coupled to bus 604 for storing information and instructions for processors 606A, 606B, and 606C.

Computer system 600 also includes computer usable non-volatile memory 610, e.g. read only memory (ROM), coupled to bus 804 for storing static information and instructions for processors 606A, 606B, and 606C. Also present in computer system 600 is a data storage unit 612 (e.g., a magnetic or optical disk and disk drive) coupled to bus 604 for storing information and instructions. Computer system 600 also includes an optional alpha-numeric input device 614 including alpha-numeric and function keys coupled to bus 604 for communicating information and command selections to processor 606A or processors 606A, 606B, and 606C. Computer system 600 also includes an optional cursor control device 616 coupled to bus 604 for communicating user input information and command selections to processor 606A or processors 606A, 606B, and 606C. In one embodiment, an optional display device 618 is coupled to bus 604 for displaying information.

Referring still to FIG. 6, optional display device 618 of FIG. 6 may be a liquid crystal device, cathode ray tube, plasma display device or other display device suitable for creating graphic images and alpha-numeric characters recognizable to a user. Optional cursor control device 616 allows the computer user to dynamically signal the movement of a visible symbol (cursor) on a display screen of display device 618. Implementations of cursor control device 616 include a trackball, mouse, touch pad, joystick or special keys on alphanumeric input device 614 capable of signaling movement of a given direction or manner of displacement. Alternatively, in one embodiment, the cursor can be directed and/or activated via input from alpha-numeric input device 614 using special keys and key sequence commands or other means such as, for example, voice commands.

Computer system 600 also includes an I/O device 620 for coupling computer system 600 with external entities. In one embodiment, I/O device 620 is a modem for enabling wired or wireless communications between computer system 600 and an external network such as, but not limited to, the Internet. Referring still to FIG. 6, various other components are depicted for computer system 600. Specifically, when present, an operating system 622, applications 624, modules 626, and data 628 are shown as typically residing in one or some combination of computer usable volatile memory 608, e.g. random access memory (RAM), and data storage unit 612. However, in an alternate embodiment, operating system 622 may be stored in another location such as on a network or on a flash drive. Further, operating system 622 may be accessed from a remote location via, for example, a coupling to the internet. In one embodiment, the present technology is stored as an application 624 or module 626 in memory locations within RAM 608 and memory areas within data storage unit 612.

The present technology may be described in the general context of computer-executable instructions stored on computer readable medium that may be executed by a computer. However, one embodiment of the present technology may also utilize a distributed computing environment where tasks are performed remotely by devices linked through a communications network.

It should be further understood that the examples and embodiments pertaining to the systems and methods disclosed herein are not meant to limit the possible implementations of the present technology. Further, although the subject matter has been described in a language specific to structural features and/or methodological acts, it is to be understood that the subject matter defined in the appended claims is not necessarily limited to the specific features or acts described above. Rather, the specific features and acts described above are disclosed as example forms of implementing the Claims.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

What is claimed is:

1. A system for performing a demand side energy management program with interoperating rules engines, said system comprising:
a first rule set containing a plurality of rules related to a demand side energy management program;
a first rules engine communicatively connected to said first rules set;
a second rule set containing a plurality of rules related to consumer preferences and level of participation in said demand side energy management program;
a second rules engine communicatively connected to said second rules set;
a third rule set containing a plurality of rules related to attached smart grid devices;
a third rules engine communicatively connected to said third rules set;
a fourth rules engine including a defined interface communicatively connected via a network to said first rules engine, said second rules engine, and said third rules engine wherein said fourth rules engine receives information and resolves constraints from said first rules engine, said second rules engine, and said third rules engine.

2. The system of claim 1, wherein said demand side energy management program is performed by a utility or energy aggregator.

3. The system of claim 1, further comprising a fifth rules engine communicatively connected to said fourth rules engine, wherein said fifth rules engine includes an arbitrary fifth rule set, and said fourth rules engines resolves constraints from said first rules engine, said second rules engine, said third rules engine and said fifth rules engine.

4. The system of claim 1, wherein said network comprises the public Internet.

5. The system of claim 1, wherein said network comprises an AMI network

6. The system of claim 1, wherein said fourth rules engine resolves the constraints from said first rules engine, said second rules engine, and said third rules engine as a boolean value.

7. The system of claim 1, wherein said first rule set contains rules pertaining to abstractions of smart grid devices.

8. The system of claim 1, wherein said fourth rules engine allocates smart grid devices to specific aggregate objectives.

9. The system of claim 7, wherein said fourth rules engine determines how said smart grid devices should be managed in said demand side energy management program.

10. The system of claim 7, wherein said fourth rules engine determines how said smart grid devices should respond to future calls in said demand side energy management program.

11. A method for performing a demand side energy management program with interoperating rules engines, said method comprising:
receiving an energy curtailment call from a demand side energy management program;
receiving information from a first rules engine communicatively connected to a first rule set containing a plurality of rules related to a demand side energy management program;
receiving information from a second rules engine communicatively connected to a second rule set containing a plurality of rules related to a consumer's preferences and level of participation in said demand side energy management program;
receiving information from a third rules engine communicatively connected to a third rule set containing a plurality of rules related to attached smart grid devices;
resolving constraint information received from said first rules engine, said second rules engine, and said third rules engine and responding to said energy curtailment call wherein the said response to said energy curtailment call does not violate any constraint of said first rule set, said second rule set, or said third rule set.

12. The method of claim 11, wherein said demand side energy management program is performed by a utility or energy aggregator.

13. The method of claim 11, further comprising receiving information from a fifth rules engine communicatively connected to said fourth rules engine, wherein said fifth rules engine includes an arbitrary fifth rule set, and resolving constraints from said first rules engine, said second rules engine, said third rules engine and said fifth rules engine.

14. The method of claim 11, The system of claim 1, wherein said fourth rules engine resolves the constraints from said first rules engine, said second rules engine, and said third rules engine as a boolean value.

15. The method of claim 11, wherein said first rule set contains rules pertaining to abstractions said smart grid devices attached to said third rules engine.

16. The method of claim 11, further comprising allocating said smart grid devices attached to said third rules engine to specific aggregate objectives.

17. The method of claim 16, further comprising determining how said smart grid devices should be managed in said demand side energy management program.

18. The method of claim 16, further comprising determining how said smart grid devices should respond to future calls in said demand side energy management program.

19. A non-transitory computer readable media to store programming instructions for performing a demand side energy management program with interoperating rules engines, said the non-transitory computer readable media comprising:
programming instructions for receiving an energy curtailment call from a demand side energy management program;
programming instructions for receiving information from a first rules engine communicatively connected to a first rule set containing a plurality of rules related to a demand side energy management program;
programming instructions for receiving information from a second rules engine communicatively connected to a second rule set containing a plurality of rules related to a consumer's preferences and level of participation in said demand side energy management program;
programming instructions for receiving information from a third rules engine communicatively connected to a third rule set containing a plurality of rules related to attached smart grid devices;
programming instructions for resolving constraint information received from said first rules engine, said second rules engine, and said third rules engine and responding to said energy curtailment call wherein the said response to said energy curtailment call does not violate any constraint of said first rule set, said second rule set, or said third rule set.

20. The non-transitory computer readable media as recited in claim 19, wherein said demand side energy management program is performed by a utility or energy aggregator.

21. The non-transitory computer readable media as recited in claim 19, further comprising programming instructions for receiving information from a fifth rules engine communicatively connected to said fourth rules engine, wherein said fifth rules engine includes an arbitrary fifth rule set, and resolving constraints from said first rules engine, said second rules engine, said third rules engine and said fifth rules engine.

22. The non-transitory computer readable media as recited in claim 19, further comprising programming instructions for resolving the constraints from said first rules engine, said second rules engine, and said third rules engine as a boolean value.

23. The non-transitory computer readable media as recited in claim 19, wherein said first rule set contains rules pertaining to abstractions said smart grid devices attached to said third rules engine.

24. The non-transitory computer readable media as recited in claim 19, further comprising programming instructions for allocating said smart grid devices attached to said third rules engine to specific aggregate objectives.

25. The non-transitory computer readable media as recited in claim 24, further comprising programming instructions for determining how said smart grid devices should be managed in said demand side energy management program.

26. The non-transitory computer readable media as recited in claim 24, further comprising programming instructions for determining how said smart grid devices should respond to future calls in said demand side energy management program.
